(19) United States
(12) Patent Application Publication
(10) Pub. No.: US 2019/0174265 A1
(43) Pub. Date: Jun. 6, 2019

(54) Method and Apparatus for Locating a Device

(71) Applicant: Nathan Chen, Milford, CT (US)

(72) Inventor: Nathan Chen, Milford, CT (US)

(21) Appl. No.: 16/266,358

(22) Filed: Feb. 4, 2019

Related U.S. Application Data
(63) Continuation-in-part of application No. 15/867,578, filed on Jan. 10, 2018.
(60) Provisional application No. 62/444,466, filed on Jan. 10, 2017.

(51) Int. Cl. H04W 4/029; H04W 4/024; G08B 21/24

(52) U.S. Cl. CPC H04W 4/029; G08B 21/24; H04W 4/024

(57) ABSTRACT

This invention comprises a unique method and apparatus for locating a lost article. In one embodiment, a target electronic device is provided. A tracking device is provided and includes hardware configured to receive and recognize a signal and also to emit a signal. A transmission medium is used to facilitate communication between the target electronic device and tracking device. In some embodiment there may be a plurality of target electronic devices, tracking devices, and transmission mediums. In some embodiments the tracking device helps guide the user to the location of the target electronic device.

### CROSS REFERENCE TO RELATED APPLICATIONS

This application is a Continuation-In-Part application of U.S. application Ser. No. 15/867,578, having a filing date of Jan. 10, 2018, and titled “Method and Apparatus for Locating a Device,” which claims the benefits of and priority to U.S. Provisional Application No. 62/444,466, having a filing date of Jan. 10, 2017, and titled “Method and Apparatus for Locating a Device.” The contents of the above-identified Applications are relied upon and incorporated herein by reference in their entirety.

### BACKGROUND OF THE INVENTION

The invention relates to a method and apparatus for locating a device.

It is a common problem that items are misplaced, moved by another individual or pet, fallen in between furniture cushions, or otherwise are lost and unable to be located. Typically, the current solution to such a problem is retracing one's steps, searching an area, and/or inquiring with individuals as to the item's last known location.

Previous work has attempted to address this issue with remote controls which, when activated, sends a signal to a remote device and instructs that device to make an audible noise in order to help the user find the lost remote device. However, for users who have hearing impairments or do not want to wake other individuals in the vicinity, this method can be limiting. This method is even more limiting when the lost device is out of earshot of the user.

Others have used a remote device and paired it with the user's cell phone using short wave Bluetooth®, and once the remote device leaves the Bluetooth range of the user's cell phone the last known location of the device is generally recorded and given to the user. However, if the remote device is moved from this location, the new or current location of the lost device is typically unknown to the user. Additionally, generally the location given to the user is a relatively broad area based off of the errors of the GPS or other tracking methods used to identify the location of the cell phone, and so even though the user may be able to find a general location, locating the lost device within that location is typically still challenging and time consuming.

These solutions require an undue amount of time and frequently result in the item being permanently lost. Additionally, these solutions have various limitations which hinder the user's ability to find the lost device. Thus, what is needed is a new and efficient method for locating missing items which overcomes these limitations.

### SUMMARY OF THE INVENTION

This invention relates to a locating device system which comprises two main components, a tracking device and a target electronic device. Both of these components in various embodiments have a variety of signals which they emit and receive, as well as in many embodiments have one or more users which interact with the components. In many embodiments the tracking device guides the user of the tracking device to the lost target electronic device.

In some embodiments guiding the user of the tracking device involves the tracking device notifying the user that they are moving closer to or farther away from the lost target electronic device.

In some embodiments the tracking device and target electronic device emit either GPS signals, cellular signals, Wi-Fi signals, or combinations thereof, and guiding the user of the tracking device involves displaying a map which shows the location of the tracking device as well as the location of the lost target electronic device.

In some embodiments the devices use an indoor position system and guiding the user of the tracking device involves using the indoor positioning system to direct the user of the tracking device to the indoor location of the target electronic device.

In some embodiments the tracking and target electronic devices further comprise a camera and a gyroscope, and guiding the user of the tracking device involves correlating the visual and gyroscopic data from the movement of the target electronic device with the visual and gyroscopic data of the tracking device as a means of directing the user of the tracking device which direction to travel.

In some embodiments the target electronic device and the tracking device run off of a battery, and the device(s) notify the user of the device(s) when the battery is running low.

In some embodiments the target electronic device notifies the user of its location via an audible noise, vibrations, or combinations thereof.

In some embodiments the various signals emitted by the target electronic device and/or the tracking device can be turned on and off, and in other embodiments the signals are constantly emitting. In some embodiments where the target electronic device has signals which can be turned on and off, the tracking device emits a first signal which instructs the tracking device to turn its signals on and the tracking device emits a second signal which instructs the tracking device to turn its signals off.

In some embodiments billing servers are used in conjunction with the various signals emitted by the devices, and in other embodiments a database of information is used which stores signal data. In some embodiments with a database of information, a specific geofence is designated which defines a region, which, if the target electronic device deviates from the region, the device is considered lost. In some embodiments the geofence is created automatically by the database and in other embodiments it is created by the user.

In some embodiments a user account is connected with the tracking device and target electronic device such that a user can sign into the account from a third device such as a computer or mobile phone and view the locations of the tracking and target electronic devices.

### BRIEF DESCRIPTION OF THE DRAWINGS

FIG. 1 depicts a method and apparatus for locating a device in accordance with the invention.

FIG. 2 depicts a example of how the invention of FIG. 1 helps the user find a device.

### DETAILED DESCRIPTION OF THE INVENTION

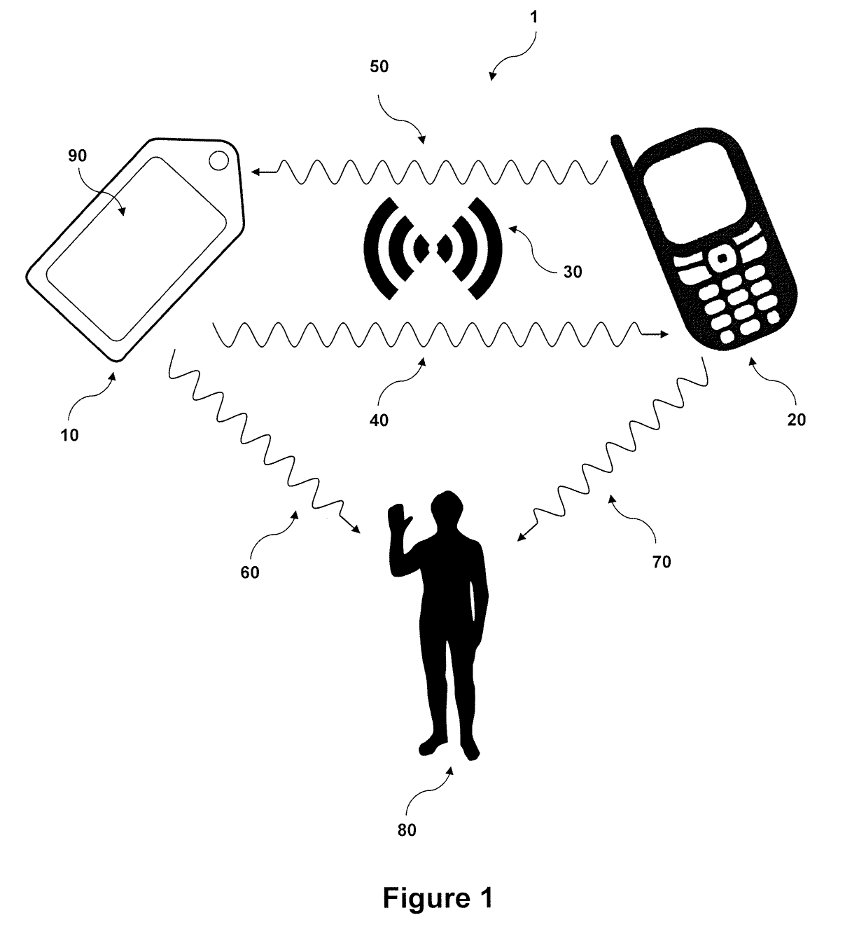

FIG. 1 shows locating device system 1 consisting of three main components, target electronic device 10, tracking device 20, and transmission medium 30. Target electronic device 10 and tracking device 20 include software in communication with hardware. The hardware on devices 10 and 20 are equipped to receive and transmit signals 40-70, and communicate via signals 40 and 50. Signals 40-70 are any signaling method, such as electromagnetic waves, audible waves, or mechanical waves.

In some embodiments target electronic device 10 is equipped with a sticker or electronic chip (90), the sticker or electronic chip further including software for communicating with hardware. In some embodiments the hardware is configured to receive and recognize signal 50. In other embodiments the hardware is configured to emit signal 40, in other embodiments the hardware is configures to emit signal 60, and in other embodiments the hardware is configured to emit both of these signals. In one embodiment there is a plurality of target electronic devices 10. Target electronic device 10 may be placed on any one or a number of commonly lost articles such as keys, wallets, purses, TV remotes, medicine bottles, cell phones, or the like.

In some embodiments, tracking device 20 includes hardware configured to receive and recognize signal 40 and also to emit a signal. In some embodiments the hardware is configured to emit signal 50, in other embodiments signal 70, and in other embodiments the hardware is configured to emit both of these signals. In some embodiments tracking device 20's hardware is configured to emit signal 50 when prompted by user 80, typically when target electronic device 10 is misplaced. In some embodiments, signal 50 is then received by the hardware of target electronic device 10. In one embodiment there may be a plurality of tracking devices 20. In some embodiments tracking device 20 comprises an application installed a device, such as a personal computer or cell phone, and in other embodiments tracking device 20 is a remote control or other similar stand-alone device.

In some embodiments, transmission medium 30 is included to facilitate communication (40 and 50) between target electronic device 10 and tracking device 20. Transmission medium 30 may be any means of facilitating communication, such as electromagnetic waves, audible waves, mechanical waves, or the like. Transmission medium 30 also includes the devices used to propagate the signals 40-70, such as satellites, cell towers, radio wave towers, or the like. In some embodiments communication occurs directly between target electronic device 10 and tracking device 20 without interception by any other devices therebetween. In other embodiments, transmission medium 30 includes one or more access points, computers, servers, networks, cellular networks, intranets, or the Internet. In other embodiments, target electronic device 10 is able to communicate with other target electronic devices 10, or other tracking devices 20, and tracking device 20 is able to communicate with other tracking devices 20 or other target electronic devices 10. In some embodiments, all devices are able to communicate with one another over transmission medium 30. In some embodiments transmission medium 30 facilitates communication according to any one or multiple communication protocols or standards such as 802.11, RFID, Bluetooth®, CDMA, TDMA, FDMA, infrared, Z-Wave®, 3G, 4G, or LTE. In some embodiments transmission medium 30 communicates over any one or multiple public or privately licensed communication bands such as 900 MHz, 2.4 GHz, or 5 GHz.

In some embodiments, when signal 50 is received by target electronic device 10's hardware, the hardware communicates with target electronic device 10's software that a wireless signal has been received. If target electronic device 10's hardware does not recognize signal 50, it does nothing. If target electronic device 10's hardware does recognize signal 50, it communicates with target electronic device 10's software which in turn instructs the hardware to emit a signal which aids in discovering the location of the target electronic device 10.

In some embodiments user 80 interacts or communicates with and instructs or informs devices 10 and/or 20. In some embodiments this interaction is via physical buttons located on the devices, in other embodiments a digital screen is provided. In some embodiments the digital screen is a visualization tool and interaction is still with physical buttons, keyboards, mice, or other similar input methods. In other embodiments the digital screen is touch sensitive and is equipped with virtual buttons, keyboards, mice, or other similar input methods. In some embodiments with a touch sensitive screen, user 80 still has the option to use physical input methods. In some embodiments separate devices are used to communicate with devices 10 and/or 20. These other devices comprise other electronic devices such as computers or cell phones, other devices 10 and/or 20, and the like.

In some embodiments, when prompted by user 80 to emit signal 50, tracking device 20 will continually emit signal 50 until target electronic device 10 is found and user 80 prompts tracking device 20 to stop emitting signal 50. In these embodiments target device 10 will emit signal(s) 40 and/or 60 the entire time it receives signal 50. In other embodiments, when prompted by user 80 to emit signal 50, tracking device 20 will emit a single pulse of signal 50. Once target electronic device 10 is found and user 80 instructs tracking device 20 of this fact, tracking device 20 will emit a second single pulse of signal 50. In these embodiments, signal 50 acts as an “on/off” switch for target electronic device 10, which will emit signal(s) 40 and/or 60 after receiving the initial pulse of signal 50 and will continue to emit until it receives the second pulse of signal 50. In some embodiments, target electronic device 10 is equipped with a way for user 80 to communicate that the device is found. In some of these embodiments, when prompted by user 80, target electronic device 10 will emit signal 40 which will instruct tracking device 20 to either stop emitting signal 50 or to emit the second pulse of signal 50, depending on the embodiments discussed above. In other embodiments target electronic device 10 is directly shut off via communication with user 80, and does not depend on communication with tracking device 20.

In another embodiment, multiple target electronic device 10s are each equipped with a sticker or electronic chip (90) that is unique to that electronic device. In some embodiments, software is configured on the sticker or electronic chip for altering the association of the specific target electronic device 10 with the specific sticker or electronic chip 90 so that any sticker or electronic chip 90 can be paired with any target electronic device 10 and any tracking device 20. In some embodiments each unique target electronic device 10 is configured to emit unique signals 40 or 60 when that specific target electronic device 10 receives and recognizes the unique signal 50 from tracking device 20. In some embodiments tracking device 20 is configured to store in memory the unique signal 50 that is associated with each unique target electronic device 10.

In some embodiments, tracking device 20 has the option of being utilized to locate multiple target electronic devices 10 individually. These embodiments are useful as it allows a single tracking device 20 to track and help locate multiple target electronic devices 10. This saves user 80 from having to own an individual tracking device 20 for each target electronic device 10, saving them the cost of purchasing multiple unnecessary tracking devices as well as the hassle of remembering and finding the specific tracking device 20 which syncs with the desired target electronic device 10. In other embodiments a single target electronic device 10 can be paired with multiple tracking device 20s. These embodiments are useful as multiple family members often want to track and locate a single target electronic device 10, such as a shared item like car keys, garage door opener, or TV remote. This way each family member can have their own tracking device 20, limiting the possibility that tracking device 20 gets lost or misplaced while being shared among different individuals.

In some embodiments, if a desired target electronic device 10 is out of range of a requesting tracking device 20, transmission medium 30 senses this and recruits further devices, towers, or servers to propagate the signal until the desired target electronic device 10 is reached. In some embodiments transmission medium 30 detects when target electronic device 10 has responded either by sensing signal 40 directly, or by receiving signal 40 from another device, including another target electronic device 10, the requesting tracking device 20, another tracking device 20, or any other device connected to transmission medium 30. In such a way, transmission medium 30 may be organized according to any one or multiple network topologies such as hub-and-spoke, ring, star, or full mesh.

In some embodiments target electronic device 10 emits an audible noise as signal 60 such that user 80 within earshot of target electronic device 10 can hear and find the lost device. In some embodiments where user 80 can directly interact with target electronic device 10, user 80 can inform target electronic device 10 that tracking device 20 is misplaced. In these embodiments, target electronic device 10 will emit signal 40 and instruct tracking device 20 to emit an audible noise as signal 70. In other embodiments, signals 60 and 70 are vibrations of devices 10 or 20, respectively. This embodiments is useful for those with hearing impairments who may not be able to hear but could see or feel the movement of the nearby devices.

The above embodiments are useful when user 80 is located near where the lost target electronic device 10 is located and would be able to audibly or physically detect the proximal device. However, in many instances target electronic device 10 is lost at an unknown or distant place, thus simply having an auditory or vibration signal would not aid user 80 in finding the lost device. Thus, in some embodiments, tracking device 20 is equipped with a screen which shows or otherwise guides user 80 to the location of target electronic device 10.

In some embodiments target electronic device 10 uses GPS as a means of denoting its location, in other embodiments Cell Tower Triangulation methods are used to triangulate its location, in other embodiments Wi-Fi Triangulation methods, and in other embodiments a combination of the above listed methods are used. In some embodiments the GPS and/or triangulation signals 40 are constantly on, and in other embodiments they only turn on when target electronic device 10 receives signal 50 from tracking device 20. Similarly, in some embodiments tracking device 20 uses GPS as a means of denoting its location, in other embodiments Cell Tower Triangulation methods are used to triangulate its location, in other embodiments Wi-Fi Triangulation methods, and in other embodiments a combination of the above listed methods are used. In some embodiments the GPS and/or triangulation signals 50 are constantly on, and in other embodiments they only turn on when user 80 instructs tracking device 20 to turn the various signals on. In these embodiments transmission medium 30 consists of the various satellites, cell towers, radio towers, or other propagation methods that help transmit and spread signals 40 and/or 50. In other embodiments internal gyroscopes are added to target electronic device 10, in some embodiments internal accelerometers, and in other embodiments a combination of an internal gyroscope and accelerometer. In some embodiments one or both of the internal accelerometer and gyroscope are added to tracking device 20.

While GPS and cell towers help in finding the general location of target electronic device 10 they often have a relatively large margin of error and have limitations within buildings. In order to overcome these limitations, in some embodiments target electronic device 10 and tracking device 20 are equipped with indoor positioning systems. In some embodiments the intensity of signal 40 received by tracking device 20 informs user 80 if they are moving closer to or farther away from target electronic device 10. In some embodiments the direction of signal 40 also aids in locating target electronic device 10. In some embodiments target electronic device 10 and tracking device 20 taps into the pre-determined signal area map of the location in which they are located. Based off of the unique Wi-Fi or other signal strength and additional factors, both device 20 and 10 will identify where in the building they are located and tracking devices 20 will guide user 80 to target electronic device 10. In some embodiments user 80 has the ability to map a location themselves, such as a home or office, in order to use the pre-determined signal map area to find target electronic device 10 in a commonly visited location where things are more likely to be misplaced.

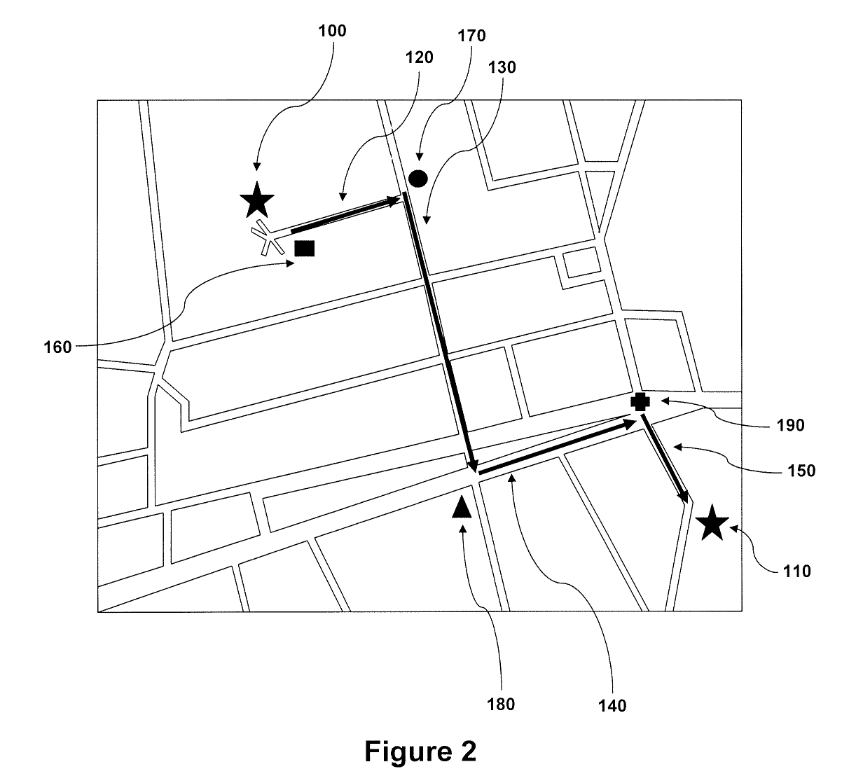

FIG. 2 shows how in some embodiments tracking device 20 guides user 80 to target electronic device 10. In some embodiments, tracking device 20 will display on a map the current location of tracking device 20 (100) and the current location of target electronic device 10 (110). In other embodiments device 20 will give directions from its current location to the location of target electronic device 10. For the example seen in FIG. 2, directions include: Enter street 120, in 0.2 miles turn right on street 130, in 0.3 miles turn left on street 140, in 0.2 turn right on street 150, and find device 10 on your left in 0.1 miles at location 110. In some embodiments the general direction in which target electronic device 10 is located in relationship to tracking device 20 will be provided on tracking device 20.

In other embodiments cameras are included on both device 20 and 10. In some embodiments the camera function of target electronic device 10 is in a constantly monitoring state which aids user 80 in visually retracing their steps. For the purposes of this application, visual data includes both individual images as well as videos or multiple images converged into a video. In some embodiments tracking device 20 uses the visual data obtained by target electronic device 10 to guide user 80 to the location of target electronic device 10. This is completed by correlating internal gyroscopic data with similar street signs, buildings, decorations, or other identifying information and instructing user 80 which direction to move which would be the same direction target electronic device 10 moved. For example, using FIG. 2, tracking device 20 would show user 80 that target electronic device 10 was moved from initial location 100 out left on street 120 (by correlating square 160 with internal gyroscopic data), then turned right on street 130 (correlating circle 170 with internal gyroscopic data), then turned left on street 140 (correlating triangle 180 with internal gyroscopic data), then turned right on street 150 (correlating cross 190 with internal gyroscopic data), and finally turned left and entered location 110.

In other embodiments the camera function of target electronic device 10 turns on when it receives signal 50 from tracking device 20. This embodiment is useful for conserving battery life and can be used to take an image or a video of the current location of target electronic device 10 which may help user 80 determine the location of the device based on its surroundings.

In some embodiments user 80 must create an online account and sync devices 10 and 20 to that account. In some of these embodiments, user 80 can sign in to their account from any internet accessible device and view the location of devices 10 and 20. These embodiments help a user 80 who may have lost tracking device 20, or both tracking device 20 and target electronic device 10.

In further embodiments of the invention, transmission medium 30 includes any one or more enhancement devices such as billing servers, accounting servers, satellite uplinks, account-linked databases, or the like. In some embodiments, enhancement devices are able to provide enhanced services. In one embodiment, each time a target electronic device 10 is found, its location is entered into a server database. Discovery of the location may be by target electronic device 10, tracking device 20, or transmission medium 30 using a GPS, radio, or triangulation techniques. Once entered into the database, a history of each target electronic device 10 is stored and queried to determine a likely location of a lost article. In another embodiment, target electronic device 10 may intermittently report its location to the database in order to keep its history current.

In some embodiments the database may be accessed by an analytics server for providing a variety of different analysis algorithms. In some embodiments the analytics server may periodically or automatically determine when target electronic devices 10 is likely to be lost, for instance, by associating its location with being outside of the bounds of what is typical for its history. In some embodiments this determination occurs instantly and in other embodiments a variable timer is set to make such a determination after a given period elapses in the abnormal location. In some embodiments user 80 can set the given time period, and in others the given time period is automatically defined. In some embodiments the analytics server is configured to be in communication with user 80's contact information in order to alert them when target electronic device 10 is believed to be lost, and in other embodiments the analytics server communicates directly through tracking device 20.

In some embodiments user 80 can define a specific geofence, which, if target electronic devices 10 deviates outside of the defined geofence, target electronic device 10 is automatically defined as being lost. In some embodiments a geofence is a specific area within a latitude and longitude coordinates. In other embodiments a geofence is an area within the range of a specific Wi-Fi network, and in other embodiments an area within the range of a specific cellular network. In some embodiments, if target electronic device 10 is placed back inside of the defined geofence, target electronic device 10 is automatically defined as no longer being lost, and in other embodiments user 80 must specifically inform the database that target electronic device 10 was found.

In some embodiments the geofence is automatically defined by the analytics server. In some embodiments the geofence is set by typical locations for target electronic device 10. In some embodiments multiple discrete geofence locations are possible. For example, using FIG. 2, if user 80's briefcase or other work related item is typically located at user 80's house (100) or office (110), in some embodiments the geofence would be defined as being the area that contains both of these locations (such as the entire map shown in FIG. 2) and in other embodiments the geofence would be the area around 100 and the area around 110. In some embodiments where there are two separate geofence locations, target electronic device 10 will not be marked as lost unless a certain amount of time passes when leaving a first geofence location to when it enters a second geofence location.

In one embodiment, transmission medium 30 may operate free of cost. In another embodiment, a billing server may be provided in order to provide a fee-for-service model. In some embodiments the billing server keeps track of the number of target electronic devices 10 owned by a given user 80 in order to charge a subscription based on the number of devices. In other embodiments the billing server charges user 80 based on the number of times they attempt to locate a lost item, in some embodiments referred to as lost item requests. In this way, a promotional number of target electronic devices 10 or lost item requests may be packaged with another retail device or service, such as a cell phone or a cell phone plan. In some embodiments user 80 is able to purchase a plan for further target electronic devices 10 or lost item requests. In some embodiments these billing servers will charge a flat rate based on the number of devices user 80 has in their possession, and in other embodiments a flat rate based on the amount of data generated or stored by user 80.

In some embodiments target electronic devices 10 are placed on discoverable items similar to a scavenger hunt. When all or the required number of items have been found by a contestant, servers on the transmission medium 30 may declare a winner and award a prize.

In some embodiments devices 10 and 20 have batteries which are non-rechargeable and must be replaced when exhausted. In other embodiments devices 10 and 20 have rechargeable batteries. In some embodiments target electronic device 10 will notify tracking device 20 when it has a low battery which needs to be replaced or recharged. In some embodiments this notification is via direct communication with tracking device 20. In other embodiments where user 80 creates an account, target electronic device 10 or tracking device 20 communicate with the account servers which send a notification to user 80's contact information. In some embodiments target electronic device 10 or tracking device 20 will emit an audible sound as signal 60 or 70, respectively, notifying user 80 that the batteries are low.

It will be appreciated that target electronic device 10, tracking device 20, and devices on transmission medium 30 may include any necessary hardware and/or software to communicate with one another. Such hardware and/or software may include a general purpose processor or CPU, an application specific integrated circuit or ASIC, and an antenna or antennas.

In some embodiments the default language is English. In other embodiments the default language can be set by the user. In other embodiments the language can be changed by the user.

These descriptions and drawings are exemplary of specific embodiments only and are not intended to be limiting to the scope of the invention defined in the claims.

1. A locating device system, comprising:
at least one tracking device which emits a tracking signal and has a current location;
at least one target electronic device which emits a target signal and has a current location;
a processor on said tracking device configured to receive said target signal;
wherein said target signal identifies the location of said target electronic device;
wherein said tracking device guides a user of said tracking device to said current location of said target electronic device using said target signal.

2. The locating device system according to claim 1 wherein said guiding comprises said tracking device informing said user of said tracking device whether they are moving closer to or farther away from said current location of said target electronic device.

3. The locating device system according to claim 1 wherein said target electronic device further comprises a battery, and wherein said target electronic device notifies said user of said tracking device when the batteries on said target electronic device are running low.

4. The locating device system according to claim 1 wherein said target signal identifies said current location of said target electronic device via a method consisting of an audible noise, a vibration of said target electronic device, and combinations thereof.

5. The locating device system according to claim 1 wherein said tracking device further emits a locating signal, and wherein said target signal and said locating signal are identified by the method comprising Global Positioning System (GPS), Cell Tower Triangulation, Wi-Fi Triangulation, or combinations thereof.

6. The locating device system according to claim 5 wherein the use of said methods comprising Global Positioning System (GPS), Cell Tower Triangulation, Wi-Fi Triangulation, or combinations thereof operate via a billing server.

7. The locating device system according to claim 5 wherein said target and locating signals can be turned on and off.

8. The locating device system according to claim 7 wherein said tracking device comprises a first and second tracking signal, and wherein said target signal turns on when said target electronic device receives said first tracking signal from said tracking device, and wherein said target signal turns off when said target electronic device receives said second tracking signal from said tracking device.

9. The locating device system according to claim 5 wherein said target and locating signals are constantly emitting.

10. The locating device system according to claim 5 wherein said guiding comprises a map showing said current location of said tracking device and said current location of said target electronic device.

11. The locating device system according to claim 5 further comprising a database of information collected from at least said target electronic device.

12. The locating device system according to claim 11 further comprising an analytical server which automatically identifies that said target electronic device is lost after said target electronic device leaves a defined geofence.

13. The locating device system according to claim 12 wherein said geofence is defined by said user of said tracking device.

14. The locating device system according to claim 12 wherein said target electronic device comprises at least one typical location and wherein said geofence is automatically defined by said analytical server based on said at least one typical location.

15. The locating device system according to claim 5 wherein said guiding comprises the use of an indoor positioning system to guide said user of said tracking device to said current location of said target electronic device when said target electronic device is indoors.

16. The locating device system according to claim 5 further comprising a user account which is linked to said tracking device and said target electronic device, and wherein said user of said tracking device can sign into said user account on a separate device and view the location of said tracking device and said target electronic device.

17. A locating device system, comprising:
at least one tracking device which emits locating data;
at least one target electronic device which emits target data and has a current location;
wherein said tracking device and said target electronic device each further comprise a camera and a gyroscope;
a data server for collecting data from said tracking device and said target electronic device;
wherein said data server correlates data from said tracking device and said target electronic device to help guide a user of said tracking device to said current location of said target electronic device.

18. The locating device system according to claim 17 wherein said correlating of said data by said data server and guiding said user of said tracking device to said current location of said target electronic device comprises:
displaying to said user of said tracking device visual data captured by said target electronic device while said target electronic device was en route to its current location,
matching visual data captured by said camera of said target electronic device at a specific location en route to said target electronic device's current location with visual data captured by said camera on said tracking device at said specific location en route to said target electronic device's current location,
using data from said gyroscope of said target electronic device to instruct said user of said tracking device which direction to turn such that their route follows the route of said target electronic device.

19. The locating device system according to claim 17 wherein said target data and said locating data includes data from Global Positioning System (GPS), Cell Tower Triangulation, Wi-Fi Triangulation, or combinations thereof.

20. The locating device system according to claim 17 wherein said target data and said locating data can be optionally halted from transmitting.
